(19) United States
(12) Patent Application Publication
(10) Pub. No.: US 2015/0160390 A1
(43) Pub. Date: Jun. 11, 2015

(54) Display Having Polarizer with Unpolarized Strip

(71) Applicant: Apple Inc., Cupertino, CA (US)

(72) Inventors: Supriya Goyal, Santa Clara, CA (US); Christopher L. Boitnott, Half Moon Bay, CA (US); Enkhamgalan Dorjgotov, San Francisco, CA (US); Li Zhang, Sunnyvale, CA (US); Masato Kuwabara, Tsukuba (JP); Nathan K. Gupta, San Francisco, CA (US); Victor H. Yin, Cupertino, CA (US); Jun Qi, Cupertino, CA (US); Adam T. Garelli, Santa Clara, CA (US); Nicholas A. Rundle, San Jose, CA (US); Dinesh C. Mathew, Fremont, CA (US); Cheng Chen, San Jose, CA (US)

(21) Appl. No.: 14/502,704

(22) Filed: Sep. 30, 2014

Related U.S. Application Data
(60) Provisional application No. 61/914,331, filed on Dec. 10, 2013.

(51) Int. Cl. G02B 5/30; B32B 38/00; H04N 5/44

(52) U.S. Cl. CPC G02B 5/3033; G02B 5/305; G02B 5/3083; H04N 5/44; B32B 38/0004; G02B 1/14

(57) ABSTRACT

Electronic devices may be provided with displays that have polarizers. A polarizer may be provided with an unpolarized strip. The unpolarized strip may extend across the width of the polarizer and may overlap a light-based component such as a camera that is located in an inactive border area of a display. The polarizer may have a polarizer layer formed form a polymer with a dichroic dye. A strip-shaped opening may be formed in the polarizer layer by cutting out a strip of the polarizer layer with a laser cutting tool or other equipment, a strip of unpolarized material may be formed in the polarizer layer using chemical bleaching, or light-based bleaching techniques may be used to form an unpolarized strip in the polarizer layer.

This application claims the benefit of provisional patent application No. 61/914,331, filed Dec. 10, 2013, which is hereby incorporated by reference herein in its entirety.

### BACKGROUND

This relates generally to electronic devices and, more particularly, to electronic devices with displays having polarizers.

Electronic devices often include displays. For example, cellular telephones, computers, and televisions have displays.

It can be challenging to mount light-based electronic components such as cameras and sensors in devices with displays. Some devices have large inactive display areas covered with protective bezels. In this type of device, a component such as a camera can be mounted under a camera window in the bezel. Although this type of arrangement will allow the camera to operate satisfactorily, the use of the bezel on the display may be unattractive band bulky. More compact and aesthetically appealing display designs are possible by mounting components in alignment with windows formed directly within an inactive border of the display. Such windows may, however, have unsightly edges or may contain polarizer material that can interfere with component performance.

It would therefore be desirable to be able to provide electronic devices with improved polarizer arrangements for accommodating components in displays.

### SUMMARY

Electronic devices may be provided with displays that have polarizers. The displays may be, for example, liquid crystal displays. The displays may have an active area such as a rectangular active area that contains an array of display pixels. The array of display pixels may display images for a user. A rectangular ring-shaped inactive area may surround the active area. Components such as light-based components may be mounted in the inactive area. For example, a camera, light sensor, or light-emitting diode may be mounted in the top center of an inactive border in a display that is mounted in a laptop computer lid.

A polarizer may be provided with a polarizer layer such as a layer of polyvinyl alcohol with a dichroic dye such as iodine. The unpolarized strip in the polarizer may be formed by cutting out a strip of the polarizer layer, by bleaching a strip of the polarizer layer using chemical bleaching, or by applying light to bleach a strip of the polarizer layer. Chemically bleached strips may be bleached using masking techniques or by temporarily removing strips of polarizer material for bleaching.

### BRIEF DESCRIPTION OF THE DRAWINGS

FIG. 1 is a perspective view of an illustrative electronic device such as a laptop computer with display structures in accordance with an embodiment.

FIG. 2 is a perspective view of an illustrative electronic device such as a handheld electronic device with display structures in accordance with an embodiment.

FIG. 3 is a perspective view of an illustrative electronic device such as a tablet computer with display structures in accordance with an embodiment.

FIG. 4 is a perspective view of an illustrative electronic device such as a display for a computer or television with display structures in accordance with an embodiment.

FIG. 5 is a cross-sectional side view of an illustrative display in accordance with an embodiment.

FIG. 6A is a front view of an illustrative display in accordance with an embodiment.

FIG. 6B is a cross-sectional side view of a polarizer window in alignment with a light-based component in accordance with an embodiment.

FIG. 7 is a front view of an illustrative display showing how a polarizer window may be formed from an elongated unpolarized strip in a polarizer in accordance with an embodiment.

FIG. 8 is a cross-sectional side view of an illustrative polarizer in accordance with an embodiment.

FIG. 9 is perspective view of a roll of polarizer material with strip-shaped unpolarized regions spanning the width of the roll in accordance with an embodiment.

FIG. 10 is a diagram showing equipment that may be used in forming an unpolarized strip in a polarizer in accordance with an embodiment.

FIG. 11 is a diagram of a system being used to attach layers of material in a polarizer in accordance with an embodiment.

FIG. 12 is a cross-sectional side view of an illustrative polarizer structure in which an opening has been formed to create an unpolarized area in accordance with an embodiment.

FIG. 13 is a cross-sectional side view of the illustrative polarizer structure of FIG. 12 following attachment of additional layers without filling the opening to form a polarizer in accordance with an embodiment.

FIG. 14 is a cross-sectional side view of the illustrative polarizer structure of FIG. 12 following incorporation of fill material into the opening and attachment of additional layers to form a polarizer in accordance with an embodiment.

FIG. 15 is a flow chart of illustrative steps involved in forming polarizers of the type shown in FIGS. 13 and 14 in accordance with an embodiment.

FIG. 16 is a cross-sectional side view of a polarizer structure having a polarizer layer from which a strip of material is being removed in accordance with an embodiment.

FIG. 17 is a cross-sectional side view of the polarizer structure of FIG. 16 to which the strip of material is being reattached after polarizer bleaching operations in accordance with an embodiment.

FIG. 18 is a cross-sectional side view of the polarizer structure of FIG. 17 following attachment of additional layers of material to form a polarizer in accordance with an embodiment.

FIG. 19 is a flow chart of illustrative steps involved in forming polarizers of the type shown in FIG. 18 in accordance with and embodiment.

FIG. 20 is a cross-sectional side view of a polarizer structure that has been provided with a patterned masking layer in accordance with an embodiment.

FIG. 21 is a cross-sectional side view of the polarizer structure of FIG. 20 following bleaching of the unmasked surface of the polarizer structure to form an unpolarized area in accordance with an embodiment.

FIG. 22 is a cross-sectional side view of a polarizer formed from the polarizer structure of FIG. 21 in accordance with an embodiment.

FIG. 23 is a flow chart of illustrative steps involved in forming a polarizer of the type shown in FIG. 22 in accordance with an embodiment.

FIG. 24 is a cross-sectional side view of a polarizer structure during light bleaching to create an unpolarized area such as an unpolarized strip spanning a roll of polarizer material in accordance with an embodiment.

FIG. 25 is a cross-sectional side view of the polarizer structure of FIG. 24 following the addition of layers of material to form a polarizer in accordance with an embodiment.

FIG. 26 is a flow chart of illustrative steps involved in forming a polarizer of the type shown in FIG. 25 in accordance with an embodiment.

### DETAILED DESCRIPTION

Electronic devices may be provided with displays. The displays may include polarizers. To create an appealing appearance for the display, the display may be mounted in a housing in a way that minimizes the use of bulky bezel structures. Transparent unpolarized regions may be formed in an inactive border of the display. The unpolarized regions may be formed using chemical bleaching of polarizer material, light bleaching, polarizer film removal, masking techniques, other fabrication techniques, or combinations of these techniques. Chemical stabilization and moisture barrier structures may help enhance reliability.

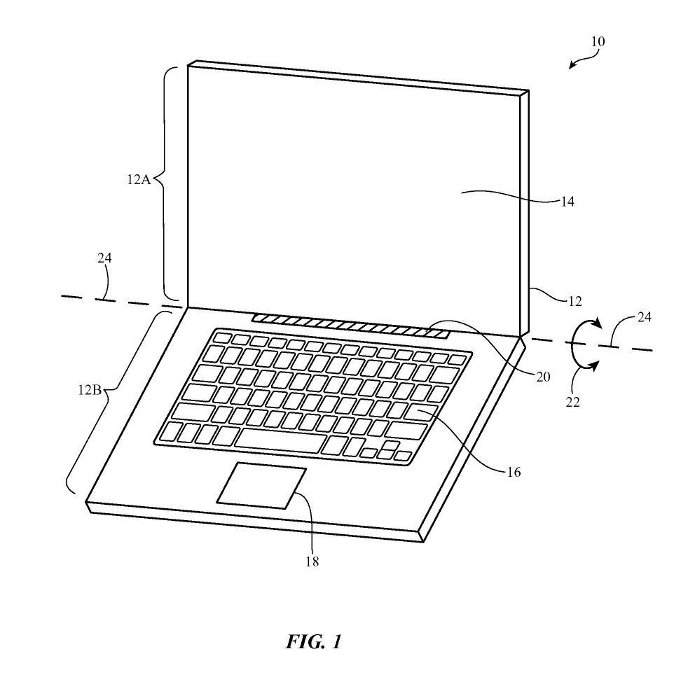

Illustrative electronic devices of the types that may be provided with displays having polarizers with unpolarized regions are shown in FIGS. 1, 2, 3, and 4.

Electronic device 10 of FIG. 1 has the shape of a laptop computer and has upper housing 12A and lower housing 12B with components such as keyboard 16 and touchpad 18. Device 10 has hinge structures 20 (sometimes referred to as a clutch barrel) to allow upper housing 12A to rotate in directions 22 about rotational axis 24 relative to lower housing 12B. Display 14 is mounted in housing 12A. Upper housing 12A, which may sometimes be referred to as a display housing or lid, is placed in a closed position by rotating upper housing 12A towards lower housing 12B about rotational axis 24.

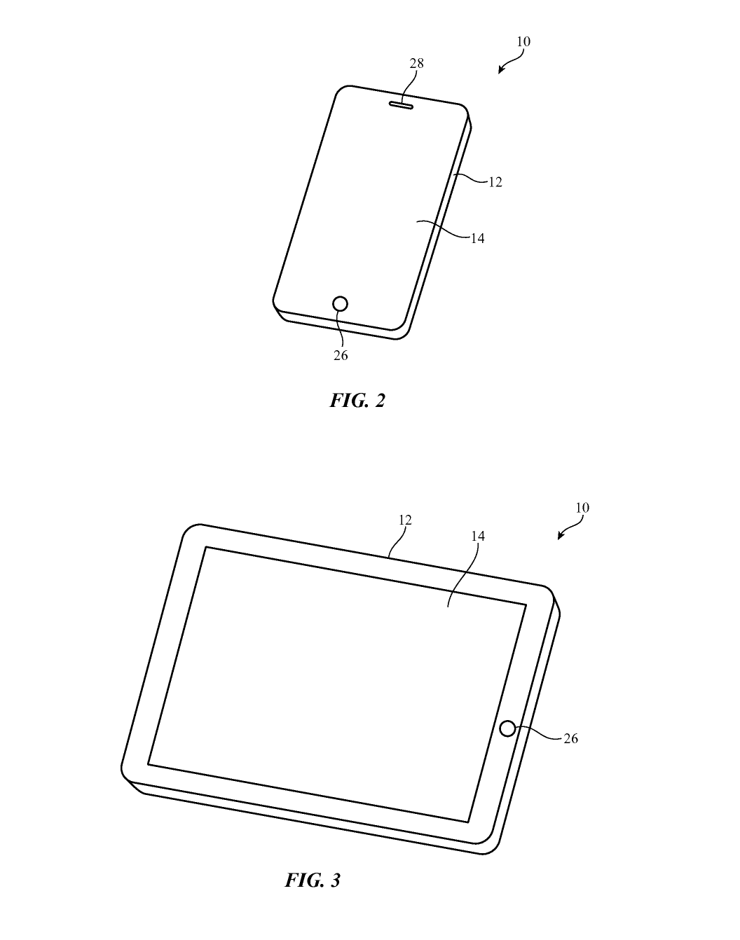

FIG. 2 shows an illustrative configuration for electronic device 10 based on a handheld device such as a cellular telephone, music player, gaming device, navigation unit, or other compact device. In this type of configuration for device 10, housing 12 has opposing front and rear surfaces. Display 14 is mounted on a front face of housing 12. Display 14 may have an exterior layer that includes openings for components such as button 26 and speaker port 28.

In the example of FIG. 3, electronic device 10 is a tablet computer. In electronic device 10 of FIG. 3, housing 12 has opposing planar front and rear surfaces. Display 14 is mounted on the front surface of housing 12. As shown in FIG. 3, display 14 has an opening to accommodate button 26.

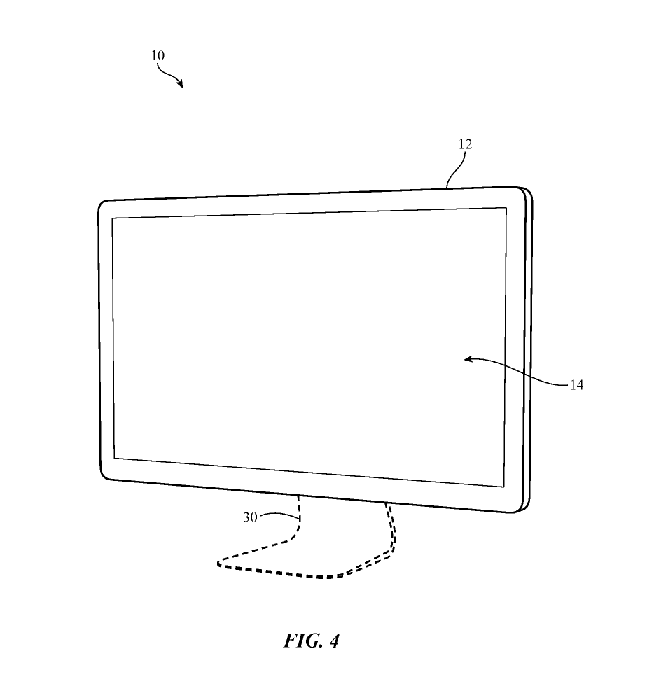

FIG. 4 shows an illustrative configuration for electronic device 10 in which device 10 is a computer display, a computer that has an integrated computer display, or a television. Display 14 is mounted on a front face of housing 12. With this type of arrangement, housing 12 for device 10 may be mounted on a wall or may have an optional structure such as support stand 30 to support device 10 on a flat surface such as a tabletop or desk.

Display 14 may be a liquid crystal display, an organic light-emitting diode display, a plasma display, an electrophoretic display, an electrowetting display, a display using other types of display technology, or a display that includes display structures formed using more than one of these display technologies. Display 14 may include one or more polarizers. For example, an organic light-emitting diode display may include a circular polarizer, a liquid crystal display may have upper and lower polarizers, etc. Configurations for display 14 in which display 14 is a liquid crystal display are sometimes described herein as an example. This is merely illustrative. Display 14 may be formed using any suitable type of display technology.

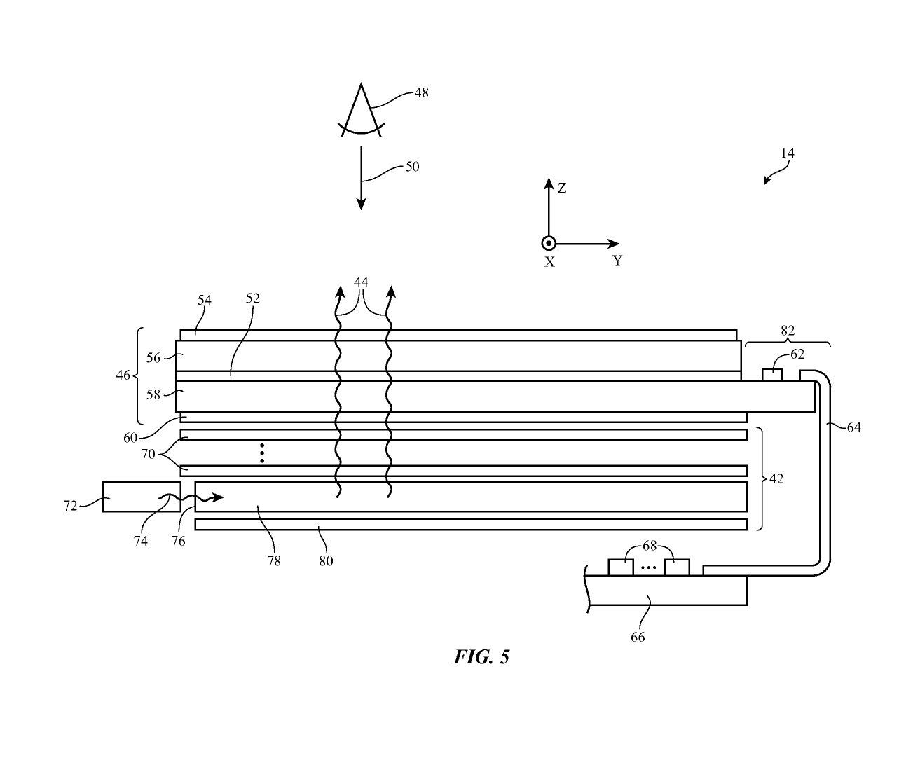

A cross-sectional side view of an illustrative configuration for display 14 of device 10 (e.g., a liquid crystal display for the devices of FIG. 1, FIG. 2, FIG. 3, FIG. 4 or other suitable electronic devices) is shown in FIG. 5. As shown in FIG. 5, display 14 may include backlight structures such as backlight unit 42 for producing backlight 44. During operation, backlight 44 travels outwards (vertically upwards in dimension Z in the orientation of FIG. 5) and passes through display pixel structures in display layers 46. This illuminates any images that are being produced by the display pixels for viewing by a user. For example, backlight 44 may illuminate images on display layers 46 that are being viewed by viewer 48 in direction 50.

Display layers 46 may be mounted in chassis structures such as a plastic chassis structure and/or a metal chassis structure to form a display module for mounting in housing 12 or display layers 46 may be mounted directly in housing 12 (e.g., by stacking display layers 46 into a recessed portion in housing 12).

Display layers 46 may include a liquid crystal layer such a liquid crystal layer 52. Liquid crystal layer 52 may be sandwiched between display layers such as display layers 58 and 56. Layers 56 and 58 may be interposed between lower (innermost) polarizer layer 60 and upper (outermost) polarizer layer 54.

Layers 58 and 56 may be formed from transparent substrate layers such as clear layers of glass or plastic. Layers 56 and 58 may be layers such as a thin-film transistor layer and/or a color filter layer. Conductive traces, color filter elements, transistors, and other circuits and structures may be formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 may be a thin-film transistor layer that includes an array of thin-film transistors and associated electrodes (display pixel electrodes) for applying electric fields to liquid crystal layer 52 and thereby displaying images on display 14. Layer 56 may be a color filter layer that includes an array of color filter elements for providing display 14 with the ability to display color images. If desired, layer 58 may be a color filter layer and layer 56 may be a thin-film transistor layer.

During operation of display 14 in device 10, control (e.g., one or more integrated circuits on a printed circuit such as integrated circuits 68 on printed circuit 66) may be used to generate information to be displayed on display 14 (e.g., display data). The information to be displayed may be conveyed to a display driver integrated circuit such as circuit 62 in region 82 using a signal path such as a signal path formed from conductive metal traces in a rigid or flexible printed circuit such as printed circuit 64 (as an example).

Backlight structures 42 may include a light guide plate such as light guide plate 78. Light guide plate 78 may be formed from a transparent material such as clear glass or plastic. During operation of backlight structures 42, a light source such as light source 72 may generate light 74. Light source 72 may be, for example, an array of light-emitting diodes.

Light 74 from light source 72 may be coupled into edge surface 76 of light guide plate 78 and may be distributed in dimensions X and Y throughout light guide plate 78 due to the principal of total internal reflection. Light guide plate 78 may include light-scattering features such as pits or bumps. The light-scattering features may be located on an upper surface and/or on an opposing lower surface of light guide plate 78.

Light 74 that scatters upwards in direction Z from light guide plate 78 may serve as backlight 44 for display 14. Light 74 that scatters downwards may be reflected back in the upwards direction by reflector 80. Reflector 80 may be formed from a reflective material such as a layer of white plastic or other shiny materials.

To enhance backlight performance for backlight structures 42, backlight structures 42 may include optical films 70. Optical films 70 may include diffuser layers for helping to homogenize backlight 44 and thereby reduce hotspots, compensation films for enhancing off-axis viewing, and brightness enhancement films (also sometimes referred to as turning films) for collimating backlight 44. Optical films 70 may overlap the other structures in backlight unit 42 such as light guide plate 78 and reflector 80. For example, if light guide plate 78 has a rectangular footprint in the X-Y plane of FIG. 5, optical films 70 and reflector 80 may have a matching rectangular footprint.

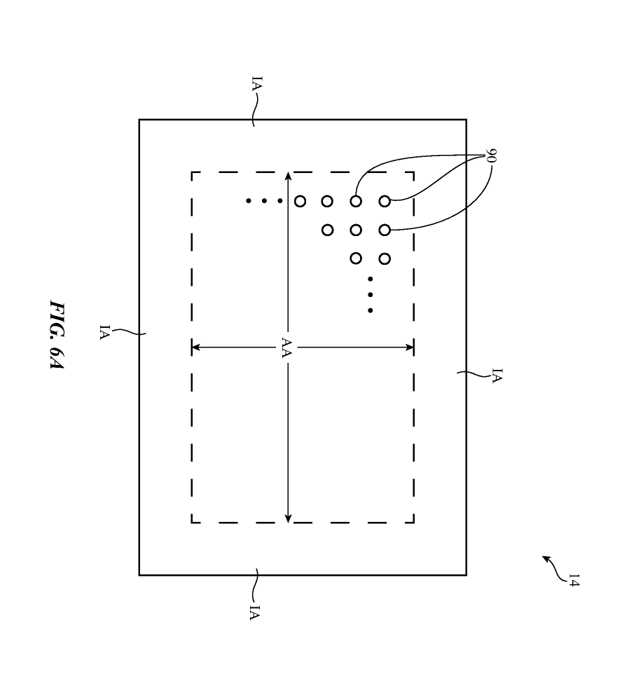

As shown in FIG. 6A, display 14 may be characterized by an active area such as active area AA. Active area AA may include an array of display pixels 90. Display pixels 90 may be used in displaying images to viewer 48 (FIG. 5) during operation of device 10. An inactive border region such as inactive area IA may surround the periphery of active area AA. For example, in a configuration of the type shown in FIG. 6A in which active area AA has a rectangular shape surrounded by four peripheral edges, inactive region IA may have the shape of a rectangular ring that runs along each of the four peripheral edges of active area AA and thereby surrounds active area AA. Displays with different active area and inactive area shapes may be used if desired. The configuration of FIG. 6A is merely illustrative.

Device 10 may include light-based components such as a camera (digital image sensor), an ambient light sensor, a light-based proximity sensor (e.g., a sensor having a light emitter and corresponding light detector), one or more light-emitting diodes serving as status indicator lights, etc. These components may be mounted under display 14 in inactive area IA. Transparent window regions may be formed in display 14 to accommodate the light-based components. The window regions may be free from polarized material. For example, upper polarizer 54 of FIG. 5 may be provided with transparent regions that are unpolarized and that therefore exhibit high transmittance (e.g., 80% or more, 90% or more, etc.). The electrical components that are overlapped by inactive area IA can be mounted in alignment with these unpolarized regions.

A cross-sectional side view of a portion of an illustrative display that has a polarizer with an unpolarized window is shown in FIG. 6B. As shown in FIG. 6B, display 14 may include display layers 46 (see, e.g., display layers 46 of FIG. 5). Display layers 46 may include display layers 46′ (e.g., a color filter layer, a thin-film transistor layer, a lower polarizer, etc.). Display layers 46 may also include upper polarizer 54. Polarizer 54 may have polarized regions such as regions 100 and an unpolarized region such as region 96 that is free of polarizing material and that therefore may form a transparent window for display 14. Light-based component 92 (i.e., a camera, a light sensor, a light emitter such as a light-emitting diode, other component(s) or combinations of two or more of these devices) may be mounted in alignment with unpolarized region 96. For example, component 92 may be mounted under region 96 so that incoming and/or outgoing light 98 that is associated with the operation of component 92 may pass through region 96. If desired, light 98 may pass through one or more transparent layers in display layers 46′. For example, glass layers, plastic layers, or other layers of material among layers 46′ may be interposed between component 92 and polarizer 54. If desired, an opening such as opening 94 may be formed in some or all of layers 46′ (e.g., to allow component 92 to be mounted closer to polarizer 54).

In some displays, it may be desirable to incorporate a layer of opaque masking material around the periphery of the display. For example, some or all of inactive area IA of display 14 (FIG. 6A) may be provided with a layer of black ink, white ink, or other opaque masking material to hide internal device components from view by a user. When forming windows for light-based components, openings may be formed in the opaque masking material in alignment with unpolarized regions. If desired, unpolarized regions may also be formed over opaque masking material or other opaque structures. For example, unpolarized regions such as region 96 of FIG. 6B may be formed over a logo in inactive area IA.

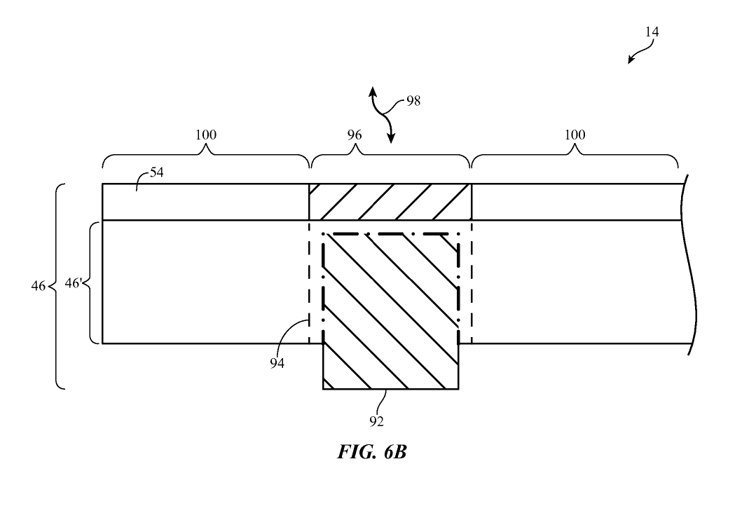

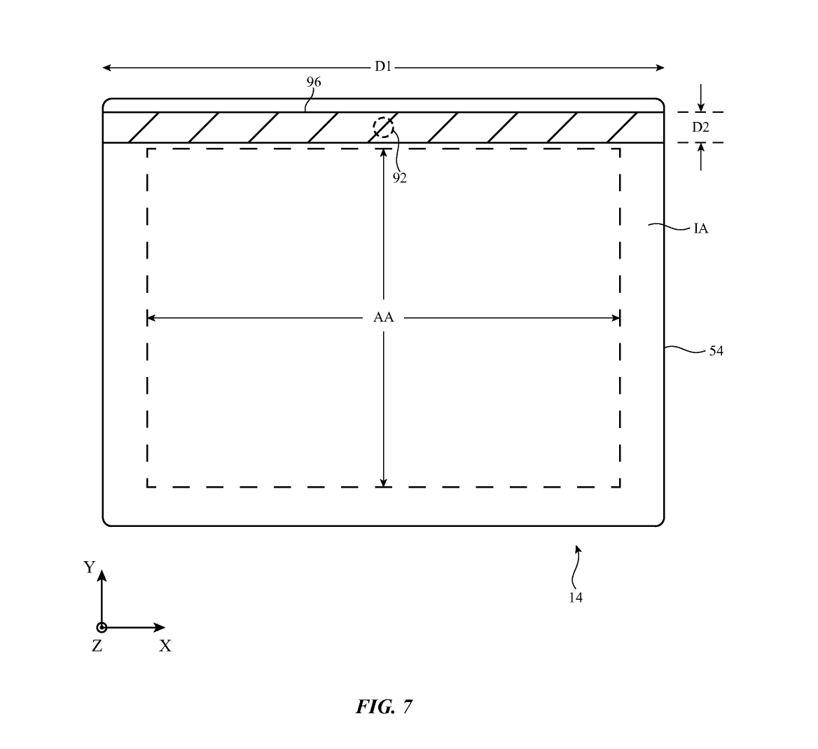

To facilitate alignment of an unpolarized window region in polarizer 54 with component 92, it may be desirable to form the unpolarized window region so that the window region has an oversized area. The oversized area may be larger the footprint of component 92, thereby increasing tolerances when assembling polarizer 54, component 92, and other structures in device 10. With one suitable arrangement, which is sometimes described herein as an example, display 14 and polarizer 54 are rectangular and have opposing upper and lower edges and opposing left and right edges, whereas unpolarized window 96 has the shape of an elongated strip (i.e., a rectangular stripe) running across the entire width of polarizer 54 from the left edge to the right edge (or has the shape of a strip that runs across at least part of the width of the polarizer). This type of configuration is shown in the illustrative top view of display 14 in FIG. 7.

As shown in FIG., 7, unpolarized region 96 of polarizer layer 54 may span the width of polarizer 54. Opaque masking material in inactive area IA may be absent under some or all of region 96 to form a transparent window. Region 96 may overlaps light-based component 92 (e.g., to accommodate light 98 associated with component 92) and/or may overlap opaque layers of material (e.g., in association with creating a logo, an opaque border, etc.). Unpolarized region 96 may have the shape of a strip with a longitudinal axis that runs along lateral dimension X and may have a relatively long dimension D1 along dimension X. Region 96 may also have a relatively narrow dimension (i.e., dimension D2) that runs along orthogonal lateral dimension Y. Unpolarized strip 96 is relatively easy to align with respect to component 92 in dimension X, because dimension Dl is typically significantly larger than the width of component 92 (and any associated opaque masking layer window opening) in dimension X. As a result, the manufacturing equipment being used to form display 14 needs primarily to perform an accurate alignment of unpolarized strip 96 with respect to component 92 in a single dimension—i.e., dimension Y.

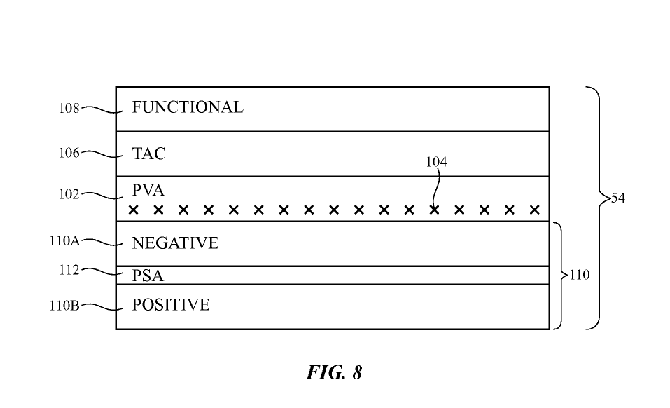

A cross-sectional side view of an illustrative polarizer for display 14 is shown in FIG. 8. As shown in FIG. 8, polarizer 54 (i.e., an upper polarizer in this example) may have a polymer layer such as polarizer film (layer) 102. Film 102 may be formed from a stretched polymer such as stretched polyvinyl alcohol (PVA) and may therefore sometimes be referred to as a PVA layer. A dichroic dye such as iodine 104 or dichroic organic pigments may be added to the stretched PVA film to provide polarizer 54 with the ability to polarizer light. Iodine 104 may, for example, be coated onto the surface of layer 102 or may otherwise be used to dope layer 102. Molecules of iodine 104 align with the stretched film of layer 102 and form the active polarizing layer of polarizer 54. Other polarizer films may be used if desired.

Polarizer film 102 may be sandwiched between other polymer layers. For example, the upper portion of layer 102 may be covered with one or more layers such as protective layer 106 and functional layer 108. Layer 106 may be formed from a clear polymer. For example, layer 106 may be formed from a material such as tri-acetyl cellulose (TAC) and may sometimes be referred to as a TAC film. The TAC layer or other supporting substrate may help support and protect the PVA film. Functional layer 108 may include one or more layers of organic and/or inorganic material that serve as an antireflection coating, antismudge coating, or antiscratch coating, or may have layers that serve two or more such functions. Moisture barrier layer(s) may be incorporated into polarizer 54 (e.g., above between layers 102 and 106 or elsewhere) to help maintain unpolarized regions (see, e.g., region 96 of FIG. 7) in their unpolarized state by blocking moisture from reaching the unpolarized regions.

Other films may be laminated to film 102 if desired. For example, lower film(s) 110 may be formed from one or more compensation films 110A and 110B (i.e., birefringent films such as cyclic olefin polymer films that help enhance off-axis viewing performance for display 14). Interposed adhesive layers such as pressure sensitive adhesive layer 112 may be used to hold some or all of the layers of material in polarizer 54 and other portions of display 14 together. A layer of pressure sensitive adhesive or other adhesive may, for example, be used to attach polarizer 54 of FIG. 8 to display layers 46 such as layer 56 of FIG. 5.

As described in connection with FIGS. 6B and 7, the presence of polarizer material over the entire surface of display 14 may create challenges in forming desired border regions and in mounting components behind display 14. For example, it may be desirable to mount components such as a camera, ambient light sensor, light-based proximity sensor, or other light-based components 92 under unpolarized portion 96 of polarizer 54. This allows the components to be hidden from view while using light that passes through the surface of display 14. In the presence of polarizer material, light transmittance is generally cut in half. The reduced amount of light that would reach a camera, light sensor, or other light-based component in this type of arrangement would tend to decrease component performance (e.g., low-light camera and sensor performance would be degraded). This challenge can be addressed by forming an unpolarized area in polarizer 54 such as illustrative unpolarized area 96 of FIG. 6B. The unpolarized area may be used in forming a light window such as a camera window or light sensor window in display 14 that is not subject to transmission losses due to polarizer material. The unpolarized area may also be used to cover other structures in display 14, if desired.

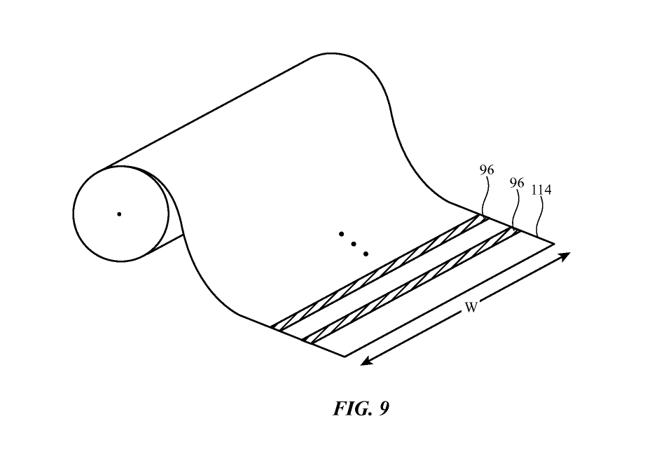

Polarizers such as polarizer 54 of FIG. 7 may be formed from rolls of flexible polymer material (i.e., sheets of polymer that are wrapped around one or more cylindrical drums). The rolls of material can be laminated together to form a roll of polarizer material that is, in turn, cut into display-sized pieces for individual displays 14. In order to accommodate roll-type fabrication processes, it may be desirable to form strips of unpolarized material 96 that span the width W of a roll of polarizer material 114, as shown in FIG. 9 (or that run along the length of a roll of material). During roll processing, one or more strips 96 can be formed using tools that are compatible with roll processing equipment.

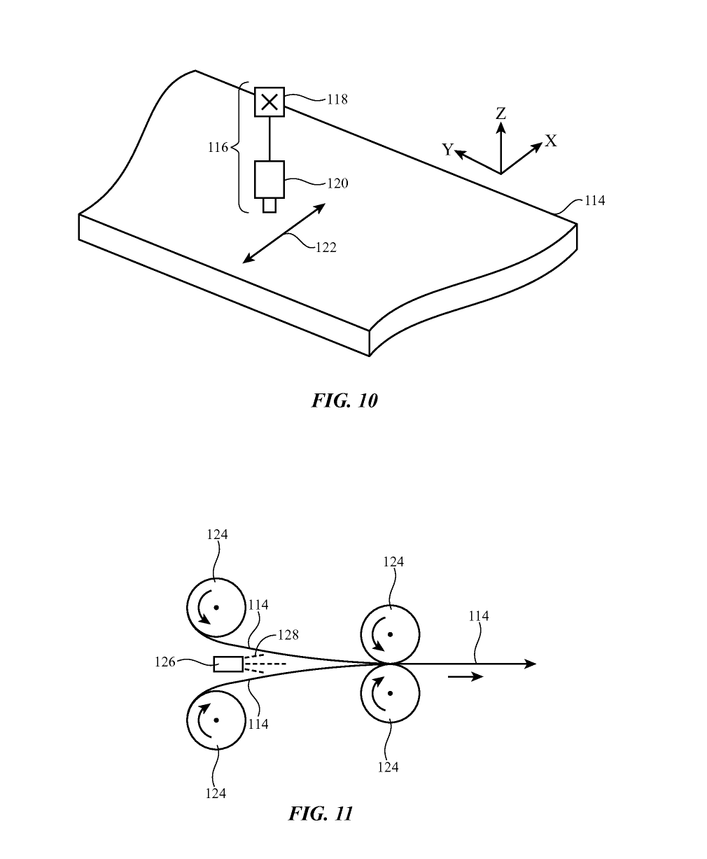

As shown in FIG. 10, for example, a roll of flexible polymer material 114 (e.g., one or more of the polymer layers in polarizer 54 of FIG. 9 such as polarizer layer 102), may be processed using equipment 116. Equipment 116 may have a computer-controlled positioner such as positioner 118 and head 120. Using positioner 118 and/or using rollers that control the dispensing of polarizer films, head 120 may be moved relative to material 114. For example, heat 120 may be moved laterally in directions 122 along dimension X across the surface of material 114 (as an example).

Equipment 116 may use head 120 to eliminate the polarization properties of material 114 (e.g., layer 102), thereby forming strip-shaped unpolarized regions that span the width of material 114, as shown in FIG. 9 (or, if desired, that run along the length of a roll of material 114). Head 120 may include chemical dispensing equipment for dispensing a polarizer bleaching agent, light emitting equipment (e.g., light for polarizer bleaching and/or light for polarizer cutting), or other equipment.

During processing of polarizer layer 102 or other portions of layer(s) 114 for polarizer 54 to form unpolarized strips 96, equipment 118 may process selected regions of layer(s) 114. In particular, selected portions of polarizer 54 (e.g., layer 102 or other portions of layer 114) may be patterned by applying light, by applying chemicals, by physically removing polarizer material, by using masking techniques during polarizer formation, or by using other polarizer patterning techniques. For example, head 120 may include a light source such as a laser or light-emitting diode that produces light. When the light strikes the iodine or other dichroic dye 104 in layer 102, the light disrupts the dye sufficiently to prevent the dye from polarizing light. Equipment 116 may move the light beam produced by head 120 relative to layer 114 during processing, thereby creating unpolarized strips 96.

If desired, chemical treatment with chemicals may be used after bleaching polarizer 54 to help stabilize the light-bleached area of the polarizer. As an example, an iodine cleaning agent such as sodium thiosulfate may be applied to the bleached area that prevents the disrupted iodine from reforming into its unbleached state (i.e., a chemical such as sodium thiosulfate may serve as a stabilizer that chemically stabilizes the bleached area).

If desired, chemical bleaching may be used to form unpolarized areas on polarizer 54 such as unpolarized strips 96. For example, equipment 116 may use head 120 to dispense a chemical bleaching agent or other suitable equipment (e.g., a screen printing apparatus, a needle dispenser, an ink jet printer, a gravure printing device, a pad printing device, a roller printing device, or other equipment) may be used to dispense a bleaching agent onto the surface of layer 114 (e.g., layer 102) to form unpolarized strips 96. The bleaching agent may be a chemical such as a strong base (e.g., KOH) that disrupts the polarization properties of the polarizer material on polarizer layer 102, thereby forming unpolarized region 96.

After forming region 96 (by chemical treatment with a chemical bleaching agent and/or light bleaching using light from a light source), chemical stabilizer (e.g., sodium thiosulfate, etc.) may optionally be applied over unpolarized region 96. If desired, polarizer layer 102 may be supported by one or more layers during bleaching. Following bleaching, polarizer layer 102 may then be stacked with additional layers 46′ above and/or below polarizer layer 102 to form polarizer 54. Additional layers may also be attached to polarizer 54 to form display layers 46 for display 14. As shown in FIG. 11, rollers such as rollers 124 may be used to attach flexible polymer layers together such as layers 114 when forming polarizer 54 and other layers in display 14. Adhesive 128 may be dispensed between layers 114 by adhesive dispenser 126 to attach layers 114 together. If desired, some of the layers of polarizer 54 and other display layers 46 may be laminated to each other using pressure (and optionally using heat) without using adhesive.

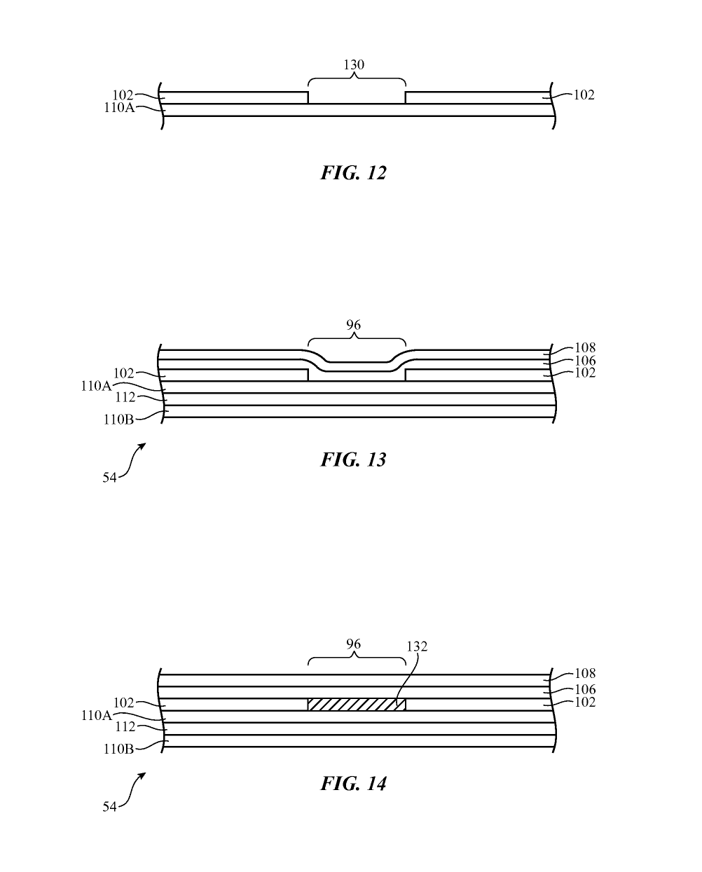

With one embodiment, a polarizer with unpolarized strip(s) may be formed using polarizer layer cutting and removal techniques. As shown in FIG. 12, polarizer layer 102 may be laminated to a substrate such as layer 110A. Layer 110A may be a compensation film that has a negative birefringence or other suitable flexile polymer layer. Opening 130 (e.g., an elongated strip) may be formed by laser cutting with equipment 116 of FIG. 10 or other suitable equipment. During laser cutting, opening 130 may be formed by cutting through layer 102 without cutting through underlying substrate layers such as layer 110A or, if desired, cuts may be made that penetrate through one or more underlying substrate layers. After cutting, the cut section of polarizer layer 102 may be removed from layer 110A to form a strip-shaped opening such as opening 130 of FIG. 12.

Polarizer layer 102 of FIG. 12 includes dichroic dye such as iodine 104, as described in connection with FIG. 8. As a result, removal of a strip of layer 102 to form strip-shaped opening 130 creates an unpolarized strip in layer 102. During subsequent operations, polarizer 54 can be formed from the polarizer structure of FIG. 12. For example, a layer of pressure sensitive adhesive such as adhesive 112 and a compensation layer such as compensation layer 110B (e.g., a compensation layer having a positive birefringence or other polymer layer) may be attached to the lower surface of layer 110A, as shown in FIGS. 13 and 14.

As shown in the illustrative polarizer configuration of FIG. 13, opening 130 can be left unfilled with additional materials. In this situation, subsequently attached layers of polarizer 54 such as protective layer 106 (e.g., a TAC layer) and functional layer 108 may fill opening 130 in unpolarized strip 96. As shown in the illustrative polarizer configuration of FIG. 14, opening 130 may, if desired, be filled with a clear filler material such as material 132 (e.g., a clear polymer such as a light-cured or thermally cured adhesive). Layer 132 may help support subsequently attached layers of polarizer 54 such as protective layer 106 (e.g.,. a TAC layer) and functional layer 108, so as to reduce the potential for visible ridges on the surface of polarizer 54 in the vicinity of unpolarized strip 96.

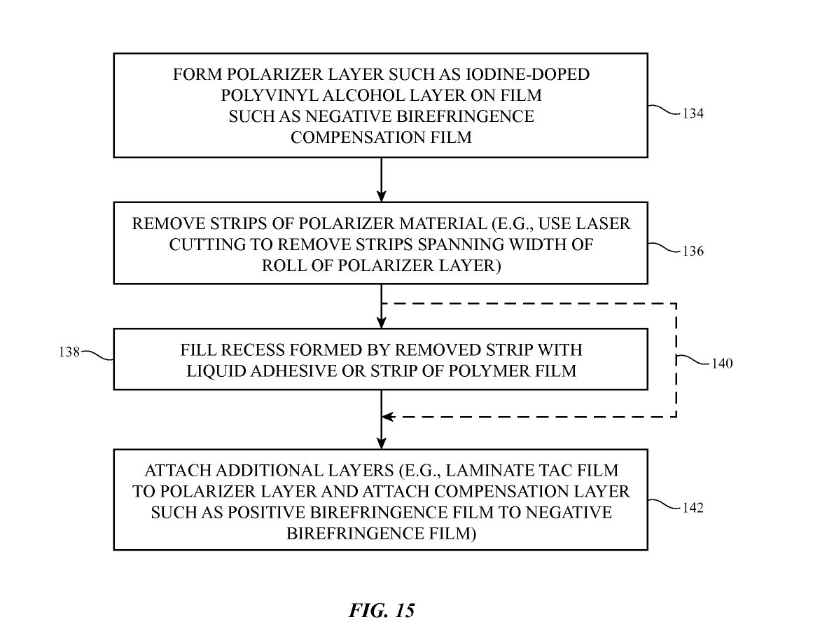

Illustrative steps involved in forming polarizers such as polarizers 54 of FIGS. 13 and 14 are shown in FIG. 15.

At step 134, a polarizer layer such as polarizer layer 102 that is formed from a stretched polymer such as polyvinyl alcohol and a dichroic dye such as iodine may be attached to a clear flexible polymer substrate layers such as a negative birefringence compensation film or other compensation layer (layer 110A).

At step 136, laser cutting, knife cutting, or other cutting and material removal techniques may be used to cut out strips of polarized materials 102, thereby forming strip-shaped openings in polarizer layer 102 such as opening 130 of FIG. 12.

At step 140, the recess formed from opening 130 in the polarizer structures (layers 102 and 110A) may be optionally filled with a liquid adhesive or other clear polymer (step 138) or step 138 may be bypassed, as indicated by line 140.

At step 142, additional layers may be attached to layers 102 and 110A to form polarizer 54 with unpolarized strip 96. For example, pressure sensitive adhesive layer 112 may be used to attach positive birefringence compensation layer 110B to the lower surface of compensation layer 110A, layers such as 106 and 108 may be laminated on top of layer 102, one or more additional pressure sensitive adhesive layers may be used to attach layer 110B and the other layers of polarizer 54 to underlying display layers 46 such as layer 58, etc.

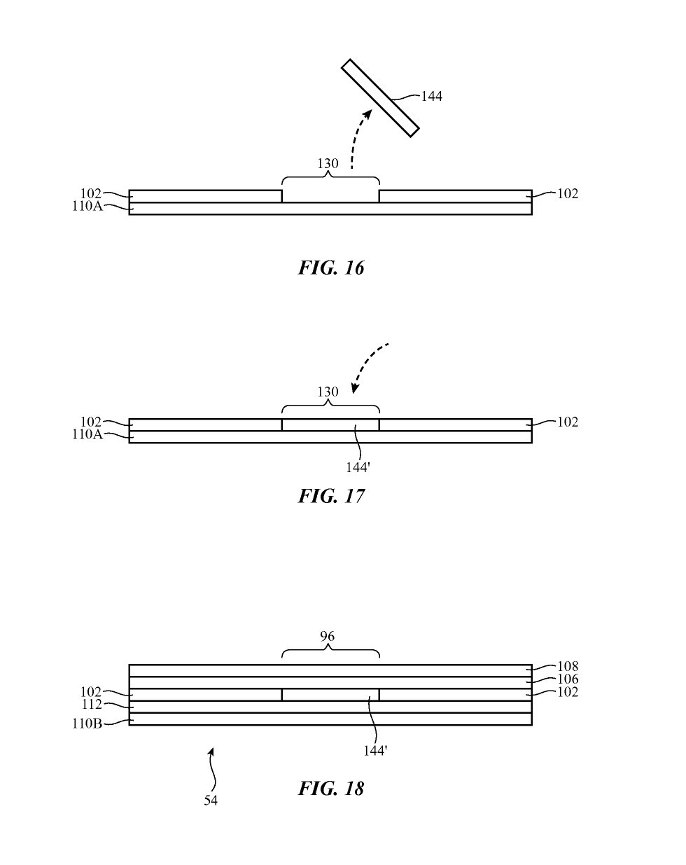

In another embodiment, selectively removed polarizer layer portions may be bleached to create unpolarized strips 96. FIGS. 16, 17, and 18 show how polarizer 54 may be formed by temporarily removing strips of polarizer layer 102, bleaching the temporarily removed strips of polarizer material to form corresponding unpolarized strips of polymer material, and by returning the unpolarized strips of material to the polarizer layer. Initially, a layer such as polarizer layer 102 may be attached to a substrate layer such as negative birefringence compensation film 110A or other display layer. Openings such as strip-shaped opening 130 may be formed in polarizer layer 102 by removing strips of polarizer layer 102 from polarizer layer 102, as illustrated by removed polarizer layer strip 144. Removed strips 144 can be wound onto a drum or otherwise supported after removal from polarizer layer 102. The drum or other support structure on which removed strips 144 are supported may be exposed to a bleaching agent (e.g., KOH) and, if desired, a chemical stabilizing agent (e.g., sodium thiosulfate or other chemical that helps prevent the bleached area from becoming polarizing again). The bleached and optionally stabilized strip (strip 144′) may then be placed back in opening 130, as shown in FIG. 17. Pressure sensitive adhesive layer 112 may be used to attach positive birefringence compensation layer 110B to the lower surface of negative birefringence compensation layer 110A and protective layer 106 and functional layer 108 may be attached above layer 102 and unpolarized strip 144′ to form polarizer 54. As shown in FIG. 18, bleached polarizer layer strip 144′ forms unpolarized strip 96 in polarizer 54.

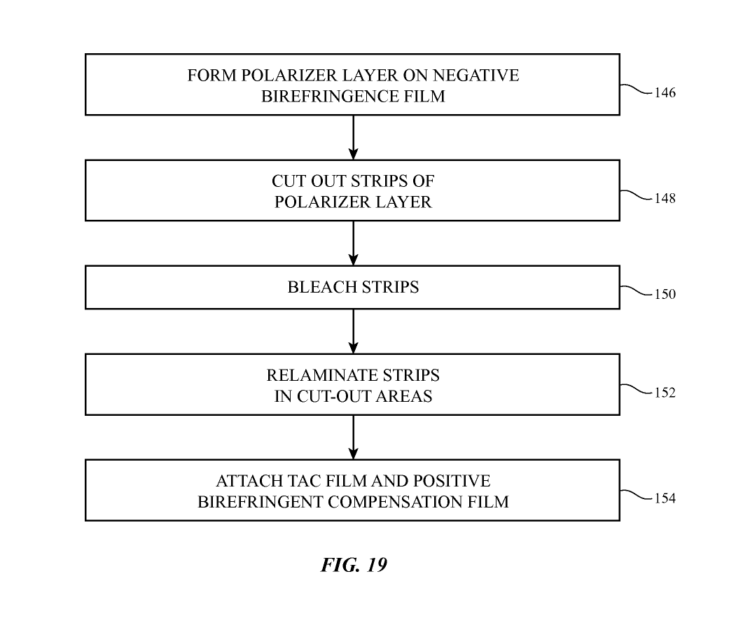

Illustrative steps involved in forming a polarizer such as polarizer 54 of FIG. 18 are shown in FIG. 19.

At step 146, polarizer layer 102 may be formed on a substrate such as negative birefringence compensation layer 110A.

At step 148, equipment such as equipment 116 of FIG. 10 (e.g., laser cutting equipment) may be used to cut strip 144 from polarizer layer 102.

Polarizer layer strip 144 may be bleached and, if desired, chemically stabilized to form bleached and unpolarized strip 144′ (step 150).

At step 152, unpolarized strip 144′ may be relaminated to the polarizer structures formed from layer 102 and layer 110A. In particular, unpolarized strip 144′ may be laminated to layer 110A within the same opening (or a similar opening) from which the strip was removed at step 148.

At step 154, additional films may be attached to layer 102 and layer 110A to form polarizer 54. For example, a layer of pressure sensitive adhesive such as adhesive layer 112 may be used to attach positive birefringence compensation film 110B to compensation layer 110A and layers such as protective polymer film 106 and functional layer 108 may be formed on top of layer 102. Because of the presence of unpolarized strip 144′ in layer 102, polarizer 54 will have an unpolarized strip 96 forming a transparent window. The thickness added to the layers of polarizer 54 by strip 144′ may help minimize ridges along the edges of unpolarized strip 96.

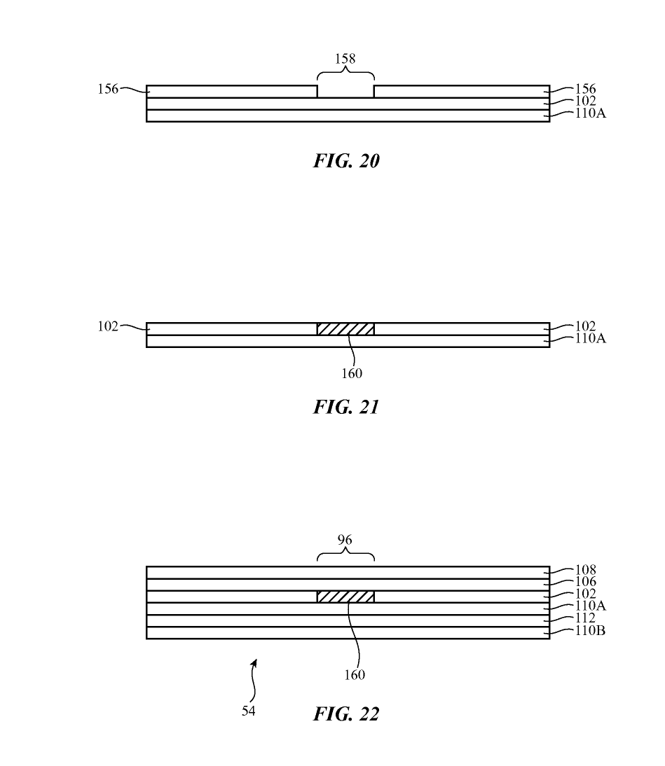

In another embodiment, masking techniques may be used to localize polarizer bleaching operations. As shown in FIG. 20, this type of arrangement involves attaching polarizer layer 102 to a substrate such as negative birefringence compensation layer 110A. Masking layer 156 may be formed on top of layer 102 and may be pattered to form openings such as strip-shaped opening 158. Masking layer 156 may be formed from a material such as a photoimageable polymer (e.g., photoresist) that is patterned using photolithographic techniques (e.g., exposure through a patterned photolithographic mask), may be created by shadow masking, may be formed by pad printing, screen printing, inkjet printing, or other patterning techniques.

After forming patterned masking layer 156 on the exposed upper surface of polarizer layer 102, bleaching agent (e.g., KOH) may be used to bleach polarizer layer 102 and mask 156 may be removed. The bleaching process bleaches a strip-shaped area of polarizer layer 102, thereby forming bleached unpolarized strip 160 of FIG. 21. A chemical stabilizer may be applied to strip 160 to help ensure that strip 160 will not revert to its original polarizing state.

After forming unpolarized strip 160 in polarizer layer 102, additional layers of material may be added to the structures of FIG. 21 to form polarizer 54 of FIG. 22. As shown in FIG. 22, for example, pressure sensitive adhesive layer 112 may be used to attach positive birefringence compensation film 110B to the underside of compensation film 110A and additional layers such as protective layer 106 and functional layer 108 may be laminated to the upper surface of polarizer layer 102, overlapping unpolarized material 160 of polarizer layer 102. In this configuration, unpolarized material 160 forms unpolarized strip 96 in polarizer 54.

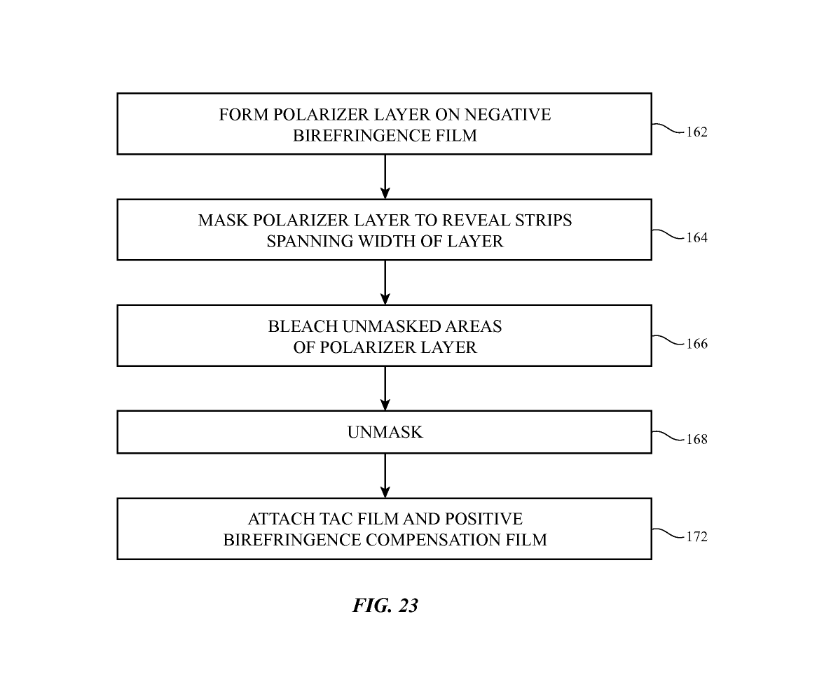

Illustrative steps involved in forming a polarizer such as polarizer 54 of FIG. 22 are shown in FIG. 23.

At step 162, polarizer layer 102 may be formed on a substrate such as negative birefringence compensation film 110A.

At step 164, a patterned masking layer such as layer 156 with strip-shaped openings such as opening 158 of FIG. 20 may be formed on layer 102. A bleaching agent may then be applied to bleach unmasked portions of layer 102 (step 166). Optional chemical stabilization may be used to help prevent the bleached portions of layer 102 from reverting to a polarizing state.

At step 168, masking layer 156 may be removed (e.g., with a solvent).

Additional layers of material may be added to the polarizer structures to form polarizer 54. For example, pressure sensitive adhesive layer 112 may be used to attach positive birefringence compensation film 110B to layer 110A, protective layer 106 may be laminated to layer 102, and functional layer 108 may be formed on layer 106. The strip-shaped bleached portion of polarizer layer 102 forms unpolarized strip 96 in polarizer 54. As with the other configurations for polarizer 54 that contain unpolarized strip 96, unpolarized strip 96 of FIG. 22, may form a transparent window that can be mounted in display 14 so as to overlap components such as component 92 in inactive area IA.

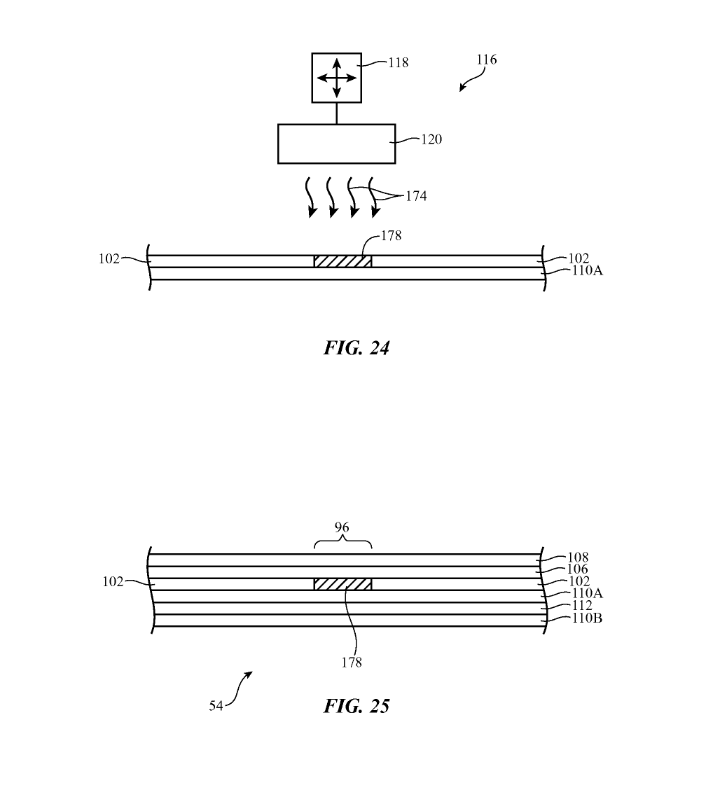

In another embodiment, light bleaching techniques may be used to form unpolarized strip 96 in polarizer 54. This type of approach is shown in FIGS. 24 and 25. As shown in FIG. 24, equipment 116 may use computer-controlled positioner 118 to move head 120 across the surface of polarizer layer 102 while head 120 emits light 174. Light 174 may be visible light or other light that bleaches polarizer layer 102 to form unpolarized strip 178. If desired, chemical stabilization may be used to help stabilize unpolarized strip 178.

As shown in FIG. 25, additional layers may be added to form polarizer 54. For example, pressure sensitive adhesive layer 112 may be used to attach positive birefringence compensation film to the lower surface of negative birefringence compensation film 110A and additional layers such as protective film 106 and functional layer 108 may be attached to the upper surface of polarizer layer 102. As shown in FIG. 25, unpolarized (light-bleached) strip 178 forms unpolarized strip 96 in polarizer 54.

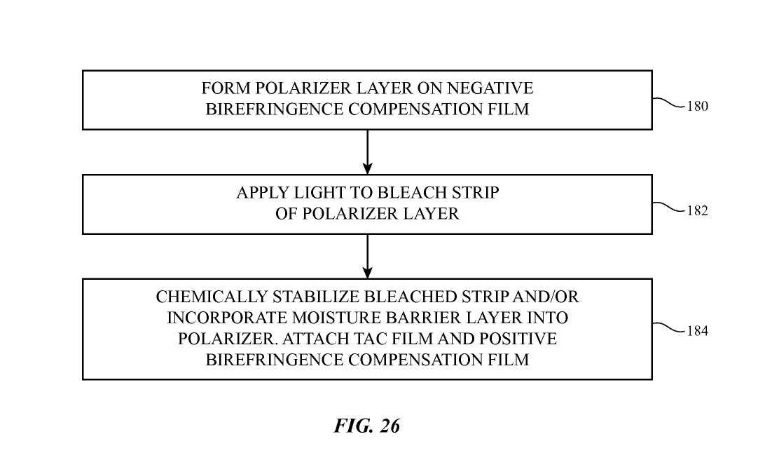

FIG. 26 is a flow chart of illustrative steps involved in forming a polarizer such as polarizer 54 of FIG. 25.

At step 180, polarizer structures are formed by adding polarizer layer 102 to a substrate such as compensation film 110A.

At step 182, equipment 116 may be used to expose a strip of polarizer 102 to light, thereby bleaching the exposed polarizer and forming an unpolarized strip in polarizer layer 102.

At step 184, optional chemical stabilization may be used to help prevent the bleached area from returning to a polarizing state. Additional layers such as layer 110B, 106, and 108 may be added to polarizer layer 102 and substrate 110A to form polarizer 54.

Regardless of the method used to bleach portions of layer 102 to form unpolarized strip 96, bleached portions of layer 102 may revert to a polarizing state from an unpolarized state in the presence of moisture. Accordingly, one or more moisture barrier layers (e.g., films with layers of inorganic material or other suitable moisture barrier materials) may be incorporated into polarizer 54 (e.g., in addition to using chemical stabilization techniques or instead of chemically stabilizing the unpolarized portion of layer 102). Moisture barrier layers may be incorporated into polarizers formed with the process of FIG. 26 and polarizers formed using other techniques (see, e.g., polarizer 54 of FIG. 18 and polarizer 54 of FIG. 22).

The foregoing is merely illustrative and various modifications can be made by those skilled in the art without departing from the scope and spirit of the described embodiments. The foregoing embodiments may be implemented individually or in any combination.

What is claimed is:

1. A display, comprising:
a rectangular active area;
an inactive border area that surrounds at least some of the rectangular active area;
a light-based component in the inactive border area; and
display layers that form an array of display pixels in the rectangular active area and that include a polarizer with an unpolarized strip that overlaps the light-based component.

2. The display defined in claim 1 wherein the polarizer has a polarizer layer and wherein the unpolarized strip comprises a bleached strip of the polarizer layer.

3. The display defined in claim 2 wherein the bleached strip of the polarizer layer comprises a light-bleached strip of the polarizer layer.

4. The display defined in claim 2 wherein the bleached strip comprises a chemically bleached strip of the polarizer layer.

5. The display defined in claim 2 wherein the bleached strip comprises a strip of material cut from the polarizer layer.

6. The display defined in claim 1 wherein the polarizer comprises a polarizer layer with a strip-shaped opening that forms the unpolarized strip.

7. The display defined in claim 6 wherein the polarizer layer comprises a polyvinyl alcohol layer.

8. The display defined in claim 6 further comprising adhesive in the strip-shaped opening.

9. The display defined in claim 8 wherein the polarizer comprises a protective film that overlaps the polarizer layer and the adhesive in the strip-shaped opening.

10. The display defined in claim 1 wherein the light-based component comprises a camera.

11. The display defined in claim 1 wherein the light-based component comprises a light-emitting diode.

12. The display defined in claim 1 wherein the light-based component comprises an ambient light sensor.

13. The display defined in claim 1 wherein the polarizer has a rectangular shape with opposing upper and lower edges and opposing left and right edges and wherein the unpolarized strip has an elongated rectangular shape that extends from the left edge to the right edge.

14. A laptop computer, comprising:
a base;
a lid;
a hinge that attaches the lid to the base;
a display in the lid;
a polarizer in the display; and
a camera in the lid, wherein the polarizer has an unpolarized strip that overlaps the camera.

15. The laptop computer defined in claim 14 wherein the polarizer comprises a polarizer layer, compensation films, and at least one additional layer on the polarizer layer.

16. The laptop computer defined in claim 15 wherein the polarizer layer has a strip-shaped opening that forms the unpolarized strip.

17. The laptop computer defined in claim 15 wherein the polarizer layer has a bleached strip of material that forms the unpolarized strip.

18. A polarizer having an unpolarized strip, comprising:
a polarizer layer formed from a polymer with a dichroic dye;
a substrate on which the polarizer layer is formed; and
a protective layer on the polarizer layer, wherein the polarizer layer has an elongated strip-shaped opening that forms the unpolarized strip.

19. The polarizer defined in claim 18 further comprising adhesive in the strip-shaped opening between the protective layer and the polarizer layer.

20. The polarizer defined in claim 19 wherein the substrate comprises a negative birefringence compensation film, the polarizer further comprising a positive birefringence compensation film, and a layer of pressure sensitive adhesive that attaches the positive birefringence compensation film to the negative birefringence compensation film.

21. The polarizer defined in claim 20 further comprising an antireflection layer on the protective layer, wherein the protective layer comprised a layer of polymer.

22. A method of forming a polarizer with an unpolarized strip, comprising:
attaching a polarizer layer to a substrate;
cutting out a strip of the polarizer layer to form a strip-shaped opening in the polarizer layer; and
attaching a protective layer to the polarizer layer over the strip-shaped opening.
